(19) United States
(12) Patent Application Publication
(10) Pub. No.: US 2026/0322942 A1
(43) Pub. Date: Oct. 15, 2026

(54) APPLICATION RELATED ICC PROFILE CREATION AND INCREMENTAL IMPROVEMENT PROCESS

(71) Applicant: Fiery, LLC, Fremont, CA (US)

(72) Inventors: GIAN LUCA COLANICCHIA, Neuss (DE); Mario Kuehn, Duisburg (DE)

(21) Appl. No.: 19/179,008

(22) Filed: Apr. 15, 2025

(51) Int. Cl. H04N 1/60; G01J 3/50; H04N 1/00

(52) U.S. Cl. CPC H04N 1/6052; G01J 3/50; H04N 1/00413; H04N 1/00514

(57) ABSTRACT

An application related ICC profile creation and incremental improvement process avoids unnecessary work, e.g. for measuring too many patches, but still achieve the color quality required for the specific production needs. Embodiments of the invention allow printing and measuring as many patches as are necessary but only as many as are needed. To offer the best suited solution, the production requirements are selectable. The set of profiling patches, number of patches, and specific color patches is defined based on the selected requirements. In another embodiment of the invention the output quality of any created media profile can be extended by measuring an additional set of patches. This allows the user to improve quality incrementally for any existing media profile, as tailored to the specific production needs.

### FIELD

Various of the disclosed embodiments concern an application related ICC profile creation and incremental improvement process.

### BACKGROUND

Media profiles are created as individual and specific color profile for any media or print resolution. To do this a sampling of a wide range of color patches is printed and subsequently measured with a color measuring device. For this effort users often select a standard chart, what they know, or what the profiling application offers. There is no relationship to the specific application for which the media profile is supposed to be used. Afterwards the so created media profile stays unchanged for a long period of time even if the application or the required accuracy needs change.

### SUMMARY

Embodiments of the invention allow an adaptation of media profile accuracy to the application requirements at creation time or a subsequent improvement at any time later.

Color profiling a media for a printer is a tedious and time-consuming process. Embodiments of the invention avoid unnecessary work, e.g. for measuring too many patches, but still achieve the color quality required for the specific production needs. Embodiments of the invention allow printing and measuring as many patches as are necessary but only as many as are needed. To offer the best suited solution, the production requirements are selectable. The set of profiling patches, including the number of patches and the specific color patches, is defined based on the selected requirements.

In another embodiment of the invention the output quality of any created media profile can be extended by measuring an additional set of patches. This allows the user to improve quality incrementally for any existing media profile, as tailored to the specific production needs.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

One or more embodiments of the present disclosure are illustrated by way of example and not limitation in the figures of the accompanying drawings, in which like references indicate similar elements.

FIG. 1 is a block diagram showing the creation of production quality optimized patch sets for media profile creation according to an embodiment of the invention;

FIG. 2 shows an example of an optional extension according to an embodiment of the invention;

FIG. 3 is a block diagram showing extension of the output quality of existing media profiles in a post profiling process with a tailored patch set according to an embodiment of the invention;

FIGS. 4A and 4B show a “641” sized profiling target according to an embodiment of the invention;

FIG. 5 shows a “242” sized additional target for gray improvement according to an embodiment of the invention;

FIGS. 6A-6C show a combined target based on the profiling target of FIG. 5 and the additional target for gray improvement of FIG. 6 according to an embodiment of the invention;

FIG. 7 is a block diagram showing extensions to current profile creation technology according to an embodiment of the invention; and

FIG. 8 is a block diagram of a computer system as may be used to implement certain features of some of the embodiments.

Those skilled in the art will appreciate that the logic and process steps illustrated in the various flow diagrams discussed below may be altered in a variety of ways. For example, the order of the logic may be rearranged, sub-steps may be performed in parallel, illustrated logic may be omitted, other logic may be included, etc. One will recognize that certain steps may be consolidated into a single step and that actions represented by a single step may be alternatively represented as a collection of sub-steps. The figures are designed to make the disclosed concepts more comprehensible to a human reader. Those skilled in the art will appreciate that actual data structures used to store this information may differ from the figures and/or tables shown, in that they, for example, may be organized in a different manner; may contain more or less information than shown; may be compressed, scrambled and/or encrypted; etc.

### DETAILED DESCRIPTION

Various example embodiments will now be described. The following description provides certain specific details for a thorough understanding and enabling description of these examples. One skilled in the relevant technology will understand, however, that some of the disclosed embodiments may be practiced without many of these details.

Likewise, one skilled in the relevant technology will also understand that some of the embodiments may include many other obvious features not described in detail herein. Additionally, some well-known structures or functions may not be shown or described in detail below, to avoid unnecessarily obscuring the relevant descriptions of the various examples.

The terminology used below is to be interpreted in its broadest reasonable manner, even though it is being used in conjunction with a detailed description of certain specific examples of the embodiments. Indeed, certain terms may even be emphasized below; however, any terminology intended to be interpreted in any restricted manner will be overtly and specifically defined as such in this Detailed Description section.

### Application Related ICC Profile Creation and Incremental Improvement Process

Embodiments of the invention offer a significant advantage for the user, offering optimal color results with a minimal effort.

The color accuracy which is the dominant part of the output color quality is strongly dependent on the effort used to measure color information during the profile creation process. A more precise color output result is accomplished when more color information is collected and more colorant patches are measured. The understanding of this fact could lead to an overcompensation. Users measure an enormous number of colorant patches but ignore what is necessary to accomplish the specific color accuracy requirements of their own print production. Operators with a less deep understanding of color science may struggle in selecting the appropriate set of colorant patches.

In addition, the increase of color accuracy is not linearly proportional to the number of measured patches and for specific needs a specific set of patches is required. State of the art color profiling applications usually offer a set of industry standard patch patterns or users may have their own, generalized, patterns. Embodiments of the invention allow the user or the profiling software product to tailor the patch pattern for the media profile creation for specific quality requirements.

In addition, adaptations are possible even after the profile creation process is completed. New and specific production or customer requirements can lead to this need. In this case, embodiments of the invention use the already captured colorant information. Only the necessary extensions are printed, measured and, in a specific process, combined with the preexisting colorant information. With this new, now extended, set of colorant information, a new media profile with identical settings is created. This process is much faster than the creation of a new media profile. It is also more predictable because already known color results become more accurate but remain in general intact. It also offers only the exactly needed extension and avoids the unnecessary, work intensive process of remeasuring a large patch set for a new media profile.

Embodiments of the invention offer two general use cases:
1. Offering production quality optimized patch sets for media profile creation.
2. Extending the output quality of existing media profiles in a post profiling process with a tailored patch set.

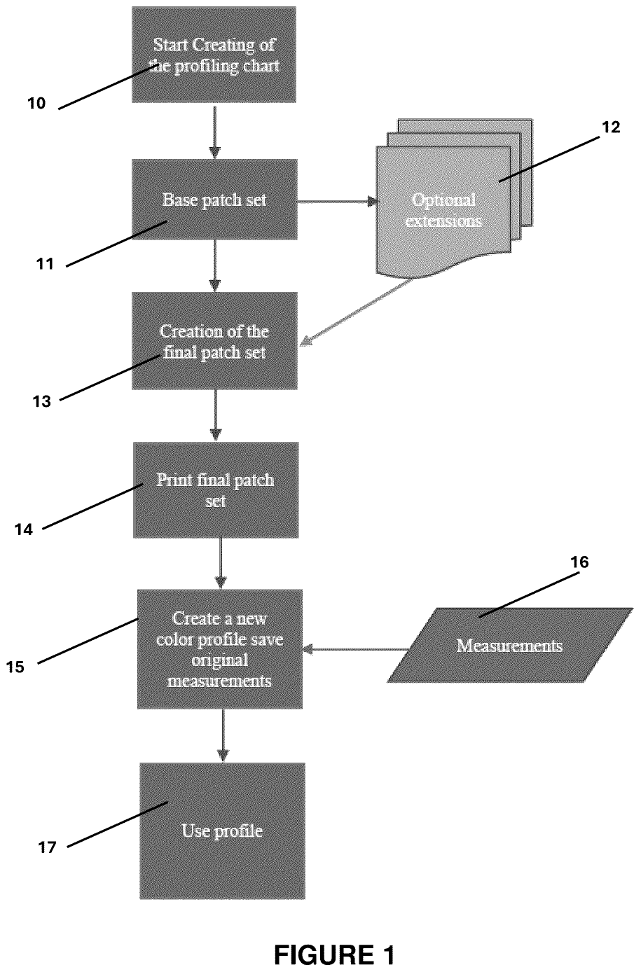

FIG. 1 is a block diagram showing the creation of production quality optimized patch sets for media profile creation according to an embodiment of the invention.

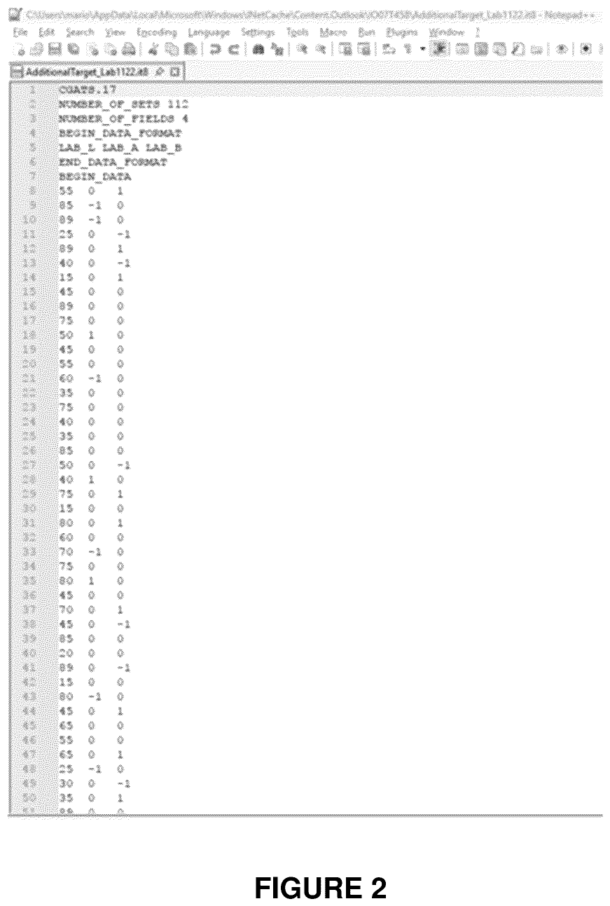

In FIG. 1, the process starts with creation of a profiling chart 10. A base patch set 11 and optional extensions 12 are used to create a final patch set 13. An example of an extension is shown in FIG. 2 which lists a set of CIE Lab definitions which can be used to improve the accuracy of the grey line. The final patch set is printed 14 and a new color profile is created 15 saving the original measurement 16. The new profile can then be used 17.

To sample the printable color gamut of a printing press correctly, the patch set that is used must fulfill a certain set of requirements. The most general requirement is that it must fit to the model that the profiling application is using. Depending on this and the number of used colorants, there is a minimal set of patches required to build a media profile. It is state of the art that additional patches are added to produce a more accurate color reproduction, neutral greys, and other important quality characteristics. The various profiling applications offer different patch patterns but, other than having a preselected default, they leave to the user the decision to use the default or any alternative and even not providing any guidance, when any alternate chart is useful.

The embodiment of the invention shown in FIG. 1 changes the state of the art significantly. Aside from a main set of patches, which is standard within all applications that create ICC profiles, a set of extensions 12, are selectable. These are optional items are not mandatory. However, instead of offering only a list of patch patterns, the user can choose what quality expectations are required, what matters most for the specific production. These settings can be made in the form of a selection, checkbox, or list box entries, or via slider settings, e.g. how much or how little a certain requirement matters to the customer. Based on these selections, additional patches, e.g. patches for a grey optimization, are added a base set of patches to accomplish the selected set of goals.

Specific goals require also specific patch sets. As an example, if the grey balance of a profile is to be improved, only patches with a recipe around the anticipated grey axis matter. There are other requirements, such as improving the global spot color accuracy, which need a global extension of the sampling. Aside of the production related requirements, press specific requirements can also be addressed.

Embodiments of the invention offer a dynamic routine that extends only the base patch pattern but does not offer one specific extension per use case. This makes the implementation very customizable. The extension may include information about the printer specific requirements that can come from a database or from a cloud storage. In this case, the user does not need to make specific settings for the definition of the profiling chart. The profiling software application can do this and then automatically tailor it to the press specific needs. This use case can become even more sophisticated with the use of AI technology. For example, assume the specific press has a color gamut with a very narrow size relative to a certain reference, e.g. the magenta of the Fogra 51. To accomplish a good color match of Fogra 51, even in the magenta region, the routine of this embodiment would add patches around the Fogra 51 magenta and would so improve the accuracy of the newly created media profile. Because of this extra effort, the user can accomplish a good reproduction of the Fogra 51 color space within the magenta region.

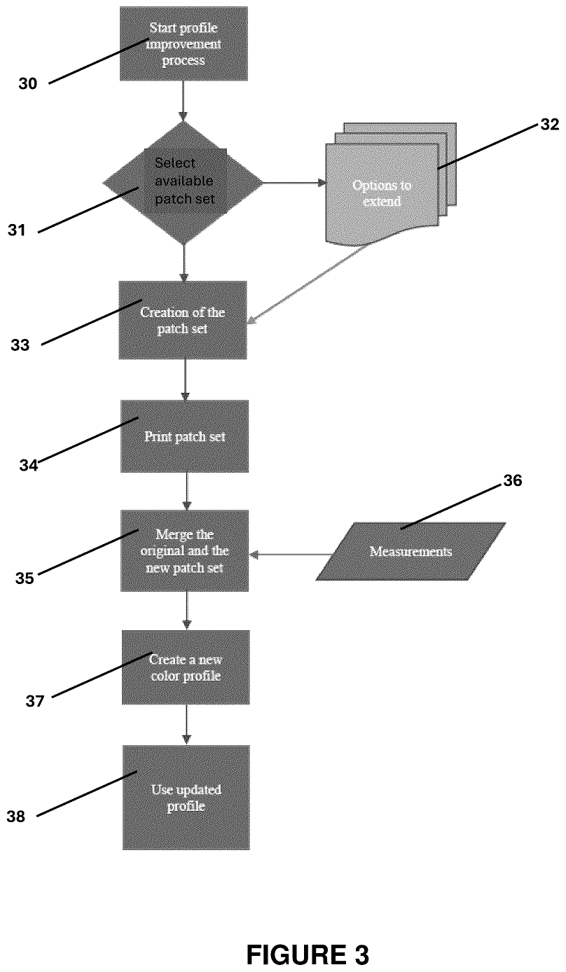

FIG. 3 is a block diagram showing extension of the output quality of existing media profiles in a post profiling process with a tailored patch set according to an embodiment of the invention. In a variation of the embodiment shown in FIG. 1, the profile improvement process starts 30. An available patch set is selected 31 and the patch set is created 33 from the selected available patch set and user options to extend 32. For purpose of the discussion herein an available patch set is the patch set which was used at the time when the initial version of the profile was built. This can be any patch set, e.g. generic or specific. Extension options can include a grey enhancement. Other options could include a spot color accuracy enhancement of a specific set of key colors (or even one single key color) or improvement of the accuracy of the reproduction of a specific standard, e.g. match the important colorant conditions of the Fogra PSD standard, etc.

The patch set is printed 34 and the original and a new patch set is merged 35 with measurements taken from new patches 36. For example, the two it8 files (FIG. 2) from the measurement devices, are simply combined. As can be seen from the example it8 files, these files include a header and a data section. If the two data sections are identically configured, a computer program can add the content of the file 2 to file 1 with a simple set of commands. But if the validation routine detects a deviation between the two data sets, this merge is not simply doable.

A new color profile is created 37 and the user applies the updated profile to print jobs 38.

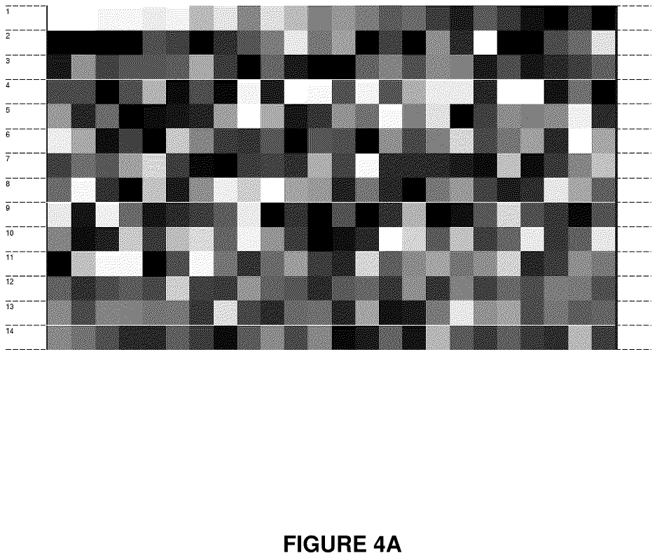

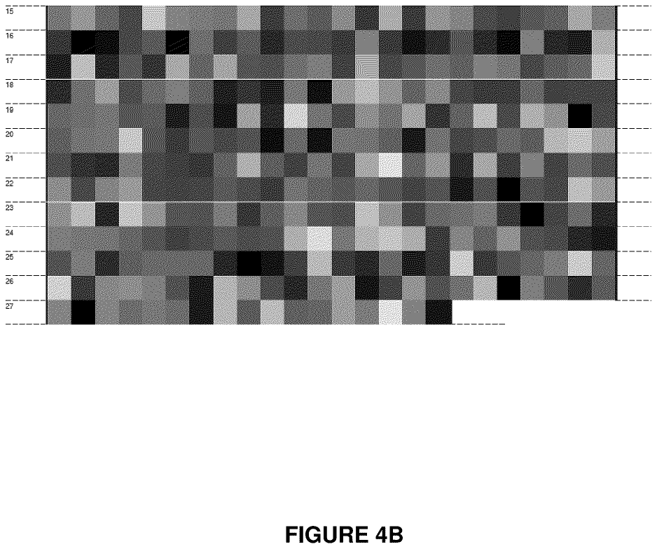

FIGS. 4A and 4B show a “641” sized profiling target according to an embodiment of the invention.

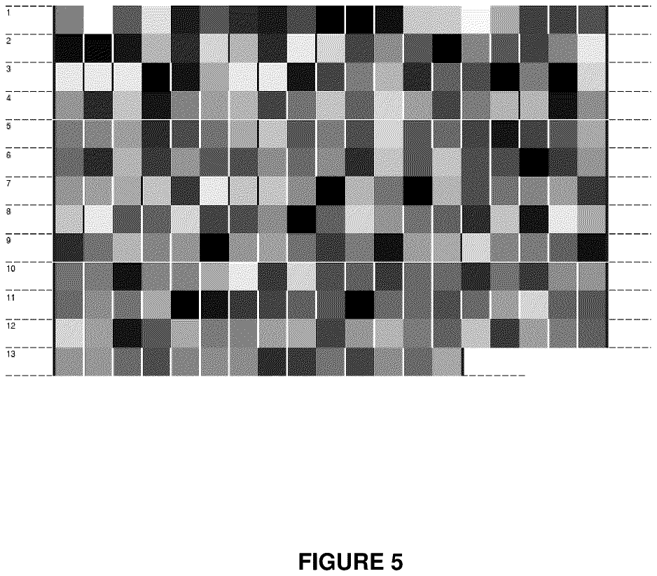

FIG. 5 shows a “242” sized additional target for gray improvement according to an embodiment of the invention.

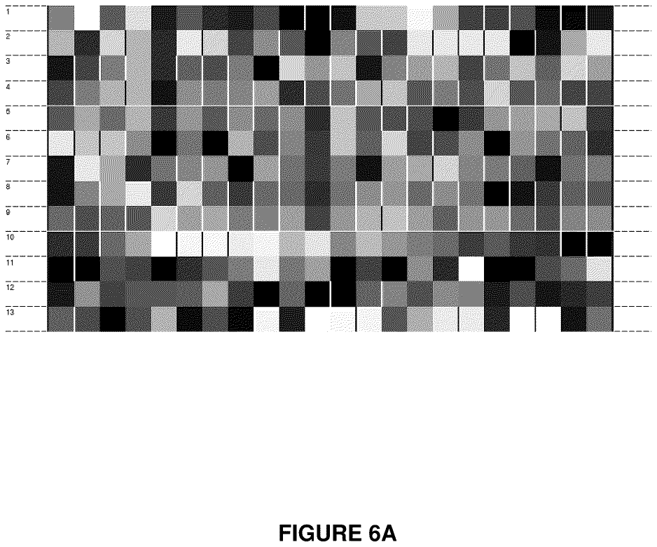

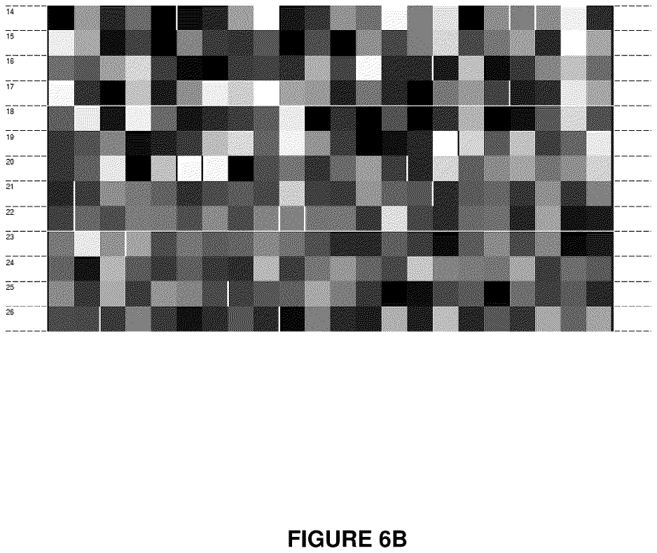

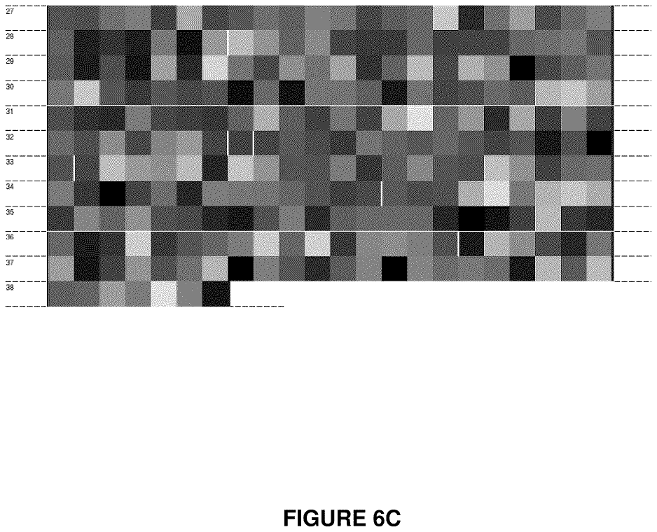

FIGS. 6A-6C show a combined target based on the profiling target of FIG. 5 and the additional target for gray improvement of FIG. 6 according to an embodiment of the invention.

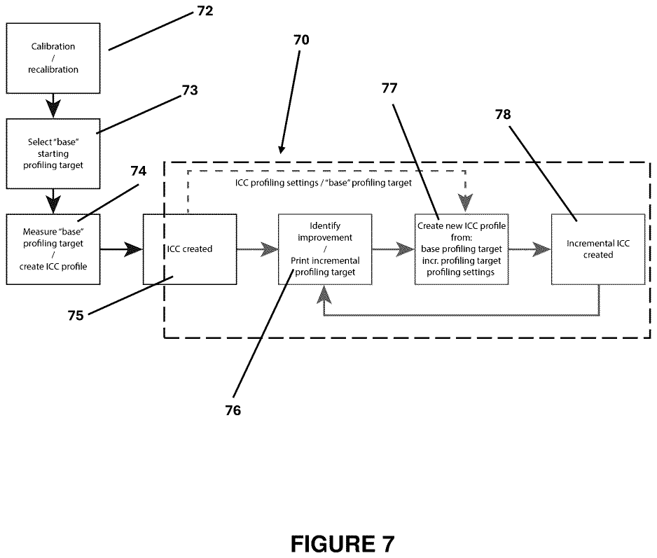

FIG. 7 is a block diagram showing extensions to current profile creation technology according to an embodiment of the invention.

In FIG. 7, the state of the art profiling process begins with a calibration/recalibration procedure 72. A base starting profiling target is selected 73. The base profiling target is measured and an ICC profile is created 74. As a result an ICC profile is provided 75. For purposes of the discussion herein a base profiling target is a target that was measured at the very beginning and, at a later state, a base profiling target is an already extended chart where the user applied certain or multiple optimizations.

Embodiments of the invention extend the state of the art profiling process by adding the steps shown in the dashed line 70. Starting with the created ICC profile 75 an improvement is identified and an incremental profiling target is printed 76. For example, the routine evaluating the measurement data and the profile creation process can detect, e.g. inconsistencies in the measurement data. These could be injected due to measurement failures. The routine could then add additional patches around this section to validate or correct the previously captured measurement data. In other embodiments of the invention, e.g. the proper representation of a certain reference or target gamut can be checked as well. If the resulting values are close to the target or even deviate, these specific parts of the gamut can be evaluated in the second print and measure step.

A new ICC profile is created from the base profiling target, an incremental profiling target, and profiling setting 77. The incremental profile is created 76 and used as an improvement is identified and an incremental profiling target is printed 76. In the end only the final, the improved, profile is used. The previous profile becomes temporary as soon as the user decides to use this optimization process.

The incremental workflow is part of the overall press calibration and profiling process. As shown in FIG. 7, with this workflow the customer can operate in a looped manner, adding incremental profiling targets at subsequent times, every time creating a new or updating an existing ICC profile.

Moreover, with the disclosed workflow, the selection of the base profiling target is less relevant, given that a profile can be updated at a later stage. This frees less skilled users from the burden of selecting the optimal profiling target at the beginning of the process of creating an ICC profile.

Embodiments of the invention also allow the user to test and qualify the newly created media profile and, if required, improve it by measuring additional color information afterwards.

As in the embodiments discussed above, this embodiment of the invention can also provide many different goal settings for such improvements and every goal can be addressed with a tailored set of patches to be printed and measured. Improvements can include, for example:
Sampling of the grayline, for improved rendition of grays.
Increasing the gamut sampling in specific areas of the gamut volume, for example for addressing accuracy issues in spot color reproduction.
Replicating already printed patches, when a printer is noisy and the measurements are uncertain, averaging old and new patches for a better printer representation.

Further, embodiments of the invention create the patch pattern based on the selected goal setting. This general approach can be combined with a parameter related to the desired strength of the effect, which impacts the number of patches in such a patch pattern. For example, to stick with the grey enhancement, the application could offer different levels of grey enhancement such as light, medium, strong. The levels of grey enhancement would differ in the number of patches which would be printed. Light=a couple, Medium=more patches, Strong=a very detailed sampling with many patches.

Also combinations of multiple goals are possible. But in any case, the resulting patch pattern is an incremental extension of the base target.

A person skilled in the art will understand that printing systems vary in print quality overtime. Because of this, the two sets of measurement data, original and newly measured, cannot be used without any adaptation. Within a specific merging process, the original and the newly captured data are integrated. The patch pattern which is extending the original profiling patch set includes patches which are also integrated into the original profiling target. For example, an algorithm can determine how much a press changed since the profile was created. With this information and a well-defined set of anchor points (points which are available in both measurement targets) a colorimetric adaptation of the newly captured measurement data becomes possible. Certain state of the art routines can be used for this. This means the adapted the original measurements of the newly captured data are not merged but the adapted ones are.

This incremental extension can be performed multiple times. Every new step can extend the available set of colorant information or replace the previous measurements.

At the end of this process a new media profile with the extended colorant information is built.

Further embodiments of the invention include:
Additional target patches sampling specific portions of the gamut.

Additional target patches replicating previously acquired patches for reducing printer noise. These patches are not removed from the profile but from the profiling measurements. Thus, there is an original profile this was built from profiling target A. After measuring an extension B, it is determined that one patch within A was incorrectly measured. This patch is also part of B and here the finding is validated because it is now measured differently. The resulting profiling patch pattern does not include the value of the patch from A but from B. Thus, the incorrect measurement is resolved.

### Computer Implementation

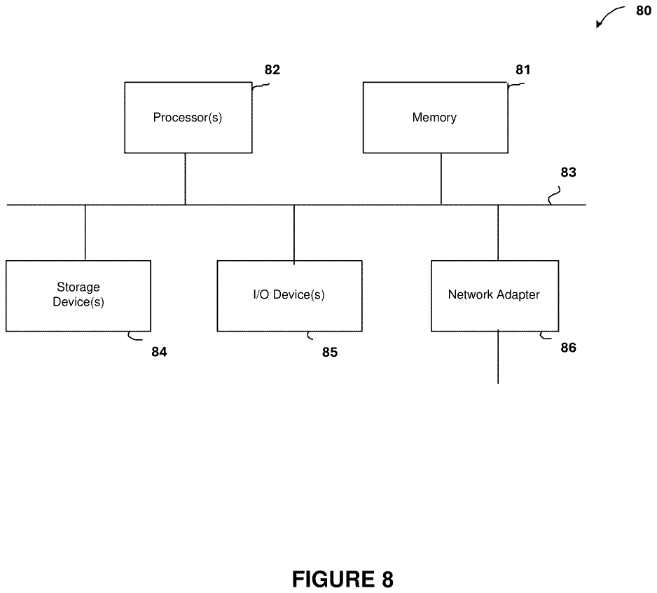

FIG. 8 is a block diagram of a computer system as may be used to implement certain features of some of the embodiments. The computer system may be a server computer, a client computer, a personal computer (PC), a user device, a tablet PC, a laptop computer, a personal digital assistant (PDA), a cellular telephone, an iPhone, an iPad, a Blackberry, a processor, a telephone, a web appliance, a network router, switch or bridge, a console, a hand-held console, a (hand-held) gaming device, a music player, any portable, mobile, hand-held device, wearable device, or any machine capable of executing a set of instructions (sequential or otherwise) that specify actions to be taken by that machine.

The computing system 80 may include one or more central processing units (“processors”) 82, memory 81, input/output devices 85, e.g. keyboard and pointing devices, touch devices, display devices, storage devices 84, e.g. disk drives, and network adapters 86, e.g. network interfaces, that are connected to an interconnect 83. The interconnect 83 is illustrated as an abstraction that represents any one or more separate physical buses, point to point connections, or both connected by appropriate bridges, adapters, or controllers. The interconnect 83, therefore, may include, for example, a system bus, a Peripheral Component Interconnect (PCI) bus or PCI-Express bus, a HyperTransport or industry standard architecture (ISA) bus, a small computer system interface (SCSI) bus, a universal serial bus (USB), IIC (12C) bus, or an Institute of Electrical and Electronics Engineers (IEEE) standard 1394 bus, also called Firewire.

The memory 81 and storage devices 84 are computer-readable storage media that may store instructions that implement at least portions of the various embodiments. In addition, the data structures and message structures may be stored or transmitted via a data transmission medium, e.g. a signal on a communications link. Various communications links may be used, e.g. the Internet, a local area network, a wide area network, or a point-to-point dial-up connection. Thus, computer readable media can include computer-readable storage media, e.g. non-transitory media, and computer-readable transmission media.

The instructions stored in memory 81 can be implemented as software and/or firmware to program the processor 82 to carry out actions described above. In some embodiments, such software or firmware may be initially provided to the processing system 82 by downloading it from a remote system through a computing system, e.g. via network adapter 86.

The various embodiments introduced herein can be implemented by, for example, programmable circuitry, e.g. one or more microprocessors, programmed with software and/or firmware, or entirely in special-purpose hardwired (non-programmable) circuitry, or in a combination of such forms. Special-purpose hardwired circuitry may be in the form of, for example, one or more ASICs, PLDs, FPGAs, etc.

### Remarks

The above description and drawings are illustrative and are not to be construed as limiting. Numerous specific details are described to provide a thorough understanding of the disclosure. However, in certain instances, well-known details are not described in order to avoid obscuring the description. Further, various modifications may be made without deviating from the scope of the embodiments.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that the same thing can be said in more than one way. One will recognize that “memory” is one form of a “storage” and that the terms may on occasion be used interchangeably.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any term discussed herein is illustrative only and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given above. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

I/We claim:

1. A system for creating and extending media profiles for color output devices, comprising:
a profiling module configured to generate a base profiling patch set for a media profile;
a user interface configured to receive user-defined quality requirements for color accuracy, spot color reproduction, or gray balance;
an extension module configured to generate an extension patch set based on the user-defined quality requirements;
a measurement module configured to collect color measurement data from the base profiling patch set and the extension patch set;
a profile generation module configured to create a media profile using the measurement data; and
a profile extension module configured to combine measurement data from the extension patch set with previously stored measurement data to generate an updated media profile.

2. The system of claim 1, wherein the extension patch set comprises one or more of:
a grey axis enhancement set;
a spot color sampling extension;
a region-specific gamut enhancement; and
a reference standard matching extension.

3. The system or method of claim 1, wherein the profiling module ins configured to use artificial intelligence to automatically determine the extension patch set based on device-specific characteristics or print quality metrics.

4. The system claim 1, further comprising:
a database or cloud-based repository adapted to store precomputed patch sets for various device types or quality goals.

5. The system of claim 1, wherein the profile extension module is configured to use anchor patches common to both the original and extended patch sets to calculate a colorimetric adaptation for merging measurement data.

6. The system of claim 1, wherein the media profile is updated in multiple incremental steps, each adding or refining specific portions of the colorant information.

7. A method for optimizing a media profile for a color output device, comprising:
generating a base profiling patch set;
receiving input specifying at least one quality improvement goal;
generating an extension patch set tailored to the quality improvement goal;
printing the extension patch set and capturing corresponding measurement data;
merging the extension measurement data with original measurement data, including adapting the data based on a colorimetric transformation to compensate for changes in print conditions; and
generating a new media profile from the merged data.

8. The method of claim 7, wherein the extension patch set comprises one or more of:
a grey axis enhancement set;
a spot color sampling extension;
a region-specific gamut enhancement; and
a reference standard matching extension.

9. The method of claim 7, further comprising:
said profiling module using artificial intelligence to automatically determine the extension patch set based on device-specific characteristics or print quality metrics.

10. The method of claim 7, further comprising:
a database or cloud-based repository storing precomputed patch sets for various device types or quality goals.

11. The method of claim 7, further comprising:
said profile extension module using anchor patches common to both the original and extended patch sets to calculate a colorimetric adaptation for merging measurement data.

12. The method of claim 7, further comprising:
updating the media profile in multiple incremental steps, each adding or refining specific portions of the colorant information.

13. A computer-implemented method for dynamically customizing profiling patch sets for creating or extending color output media profiles, comprising:
receiving user inputs or system-detected conditions specifying one or more profiling objectives;
selecting a base patch set;
dynamically generating one or more patch set extensions based on the profiling objectives and a strength parameter defining the number and distribution of patches;
combining the base patch set and one or more patch set extensions;
printing and measuring the combined patch set; and
generating or updating a media profile using the resulting measurement data.

14. The method of claim 13, further comprising:
selecting the profiling objectives via a graphical user interface element selected from a checkbox, dropdown list, or slider control.

15. The method of claim 13, wherein the strength parameter defines a density of sampling patches such that:
a “light” level includes a minimal number of additional patches;
a “medium” level includes a moderate number of patches; and
a “strong” level includes a high-density sampling for maximum profiling precision.

16. The method of claim 13, further comprising:
replicating patches from the base set within the extension patch set to detect and correct measurement noise or errors in the base set.

17. The method of claim 13, further comprising:
adapting the patch set to a reference standard, wherein the extension patch set is generated to improve reproduction accuracy in a color region specific to the reference standard.

18. The method of claim 13, wherein the profiling objectives include matching the print output to a color reference profile, and the extension patch set includes additional samples concentrated in regions of mismatch.

19. The method of claim 18, wherein the color reference profile comprises Fogra 51.
